(19) United States
(12) Patent Application Publication
(10) Pub. No.: US 2015/0339359 A1
(43) Pub. Date: Nov. 26, 2015

(54) COMPUTER SYSTEM, METADATA MANAGEMENT METHOD, AND RECORDING MEDIUM

(71) Applicant: Hitachi, Ltd., Tokyo (JP)

(72) Inventors: Nobumitsu TAKAOKA, Tokyo (JP); Shoji KODAMA, Tokyo (JP)

(21) Appl. No.: 14/426,280

(22) PCT Filed: Feb. 6, 2013
(86) PCT No.: PCT/JP2013/052661

§ 371 Date: Mar. 5, 2015

(51) Int. Cl. G06F 17/30

(52) U.S. Cl. CPC G06F 17/30563; G06F 17/30292

(57) ABSTRACT

An object of the invention is to manage correspondence between data having different schemas stored in process servers, data warehouses, or the like in the computer system having a complicated modularity configuration in an integrated manner. The computer system includes a storage portion that maintains schema correspondence information indicating correspondence of metadata described in different schema formats; a storage device that stores metadata in a second schema format different from a first schema format, which is transformed based on the schema correspondence information in a manner of being associated with corresponding actual data and a unified ID; an index portion that acquires the metadata and the unified ID in the second schema format from the storage device and maintains the metadata index transformed in a third schema format different from the first and second schema formats based on the schema correspondence information; and an update managing portion that specifies the unified ID of the metadata to be an update target by using the schema correspondence information in response to an update request of the metadata having a predetermined schema format.

### TECHNICAL FIELD

The present invention relates to a computer system, a metadata management method, and a recording medium, and particularly to a computer system that processes data having different schema formats.

### BACKGROUND ART

The data to be processed in the computer system in the recent years has various types of data formats such as structured data, semi-structured data, and unstructured data, and requires mass process of the data. According to this background, a computer system architecture that manages database having massive data such as data warehouse, and shares and uses the data of the data warehouse by various types of homogenous or heterogeneous process servers has been introduced. For example, the data of the data warehouse are caused to be shared by enabling various analysis process servers or search servers for managing searching index to be arbitrarily added. The system is a computer system having a modularity configuration that can deal with various needs of various kinds and massive amounts of data processing.

In addition, in the computer system having such an architecture, attribute information (hereinafter, referred to as “metadata”) relating to the structured data, the semi-structured data, and the unstructured data described above is used. For example, in the data search process, the search index is generated by the metadata, and search or the like by using attributes in addition to the information indicated by actual data itself is realized, so that multidimensional data utilization becomes possible.

However, in order to easily expand the process server for sharing the data of the data warehouse, the relationship between the schema of the data stored in the data warehouse and the schema of the data used in the respective process servers have to be considered. That is, even if the data has the same meaning, if the schemas are different, the data cannot be shared.

At this point, PTL 1 discloses a mapping definition creation system for creating the mapping definition which is a transformation rule when structured data according to a transformation source structured data definition is transformed to a transformation target structured data definition format. In this system, a set of different elements of a transformation source and a transformation target is mapped, so that the data in which the data definition is transformed is generated based on the mapping information.

### CITATION LIST

### Patent Literature

PTL 1: JP-A-2009-211599

### SUMMARY OF INVENTION

### Technical Problem

However, a configuration in which functions of transforming the schema of the data stored in the data ware house or the like to the schema to be used in the respective process servers are installed in the respective process servers by using the technique of PTL 1 causes the deterioration of the extensibility of the process servers.

Further, if the update of the data stored in the data warehouse is performed after the schema of the data from the data warehouse is transformed and the data is stored in the process server, there is a problem in that the update process of the data stored in the process server cannot be performed until the update on the data warehouse side is completed.

In the computer system of the complicated modularity configuration, the management of the correspondence of data having different schemas stored in the respective process servers or the data warehouse is an important issue in realizing various kinds and massive amount of data process.

### Solution to Problem

In order to solve the problems described above, the configurations described in the claims are applied. That is, provided is a computer system including a storage portion that maintains schema correspondence information indicating correspondence of metadata described in different schema formats; a storage device that stores metadata in a second schema format different from a first schema format, which is transformed based on the schema correspondence information in a manner of being associated with corresponding actual data and a unified ID; an index portion that acquires the metadata and the unified ID in the second schema format from the storage device and maintains the metadata index transformed in a third schema format different from the first and second schema formats based on the schema correspondence information; and an update managing portion that specifies the unified ID of the metadata to be an update target by using the schema correspondence information in response to an update request of the metadata having a predetermined schema format.

### Advantageous Effects of Invention

According to an aspect of the invention, with respect to the computer system sharing the data in plural computers that deal with data having different schemas, the correspondence between data having different schemas can be managed in an integrated manner so that the availability and the extensibility of the system increase.

Other objects and the effects become clear from the description below.

### BRIEF DESCRIPTION OF DRAWINGS

FIG. 1 is a diagram schematically illustrating a concept example of a computer system according to a first embodiment to which the invention is applied.

FIG. 2 is a block diagram illustrating an example of a configuration of the computer system according to the first embodiment.

FIG. 3 is a diagram schematically illustrating an example of a unified schema definition according to the first embodiment.

FIG. 4 is a diagram schematically illustrating an example of an image schema definition of the computer system according to the first embodiment.

FIG. 5 is a diagram schematically illustrating an example of indicating search index schema definition information of the computer system according to the first embodiment.

FIG. 6 is a diagram schematically illustrating an example of an update request schema definition of the computer system according to the first embodiment.

FIG. 7 is a diagram schematically illustrating an example of schema mapping of the computer system according to the first embodiment.

FIG. 8 is a diagram schematically illustrating an example of a search index table of the computer system according to the first embodiment.

FIG. 9 is a diagram schematically illustrating an example of system configuration information of the computer system according to the first embodiment.

FIG. 10 is a diagram schematically illustrating an example of metadata of the computer system according to the first embodiment.

FIG. 11 is a flow chart illustrating an example of a data collection and index generating process according to the first embodiment.

FIG. 12 is a flow chart illustrating an example of a metadata update process according to the first embodiment.

FIG. 13 is a flow chart illustrating a flow of a metadata update process on a storage side according to the first embodiment.

FIG. 14 is a flow chart illustrating a flow of metadata update process on a storage side according to a modification example of the first embodiment.

FIG. 15 is a diagram illustrating a conceptual example of a computer system according to a second embodiment.

FIG. 16 is a block diagram illustrating an example of a configuration of a computer system according to the second embodiment.

FIG. 17 is a diagram schematically illustrating an example of update record information according to the second embodiment.

FIG. 18 is a diagram schematically illustrating an example of a metadata update process in the computer system according to the second embodiment.

FIG. 19 is a diagram schematically illustrating an example of a search process using update record information in the computer system according to the second embodiment.

### DESCRIPTION OF EMBODIMENTS

Hereinafter, embodiments for practicing the invention are described with reference to the drawings.

### First embodiment

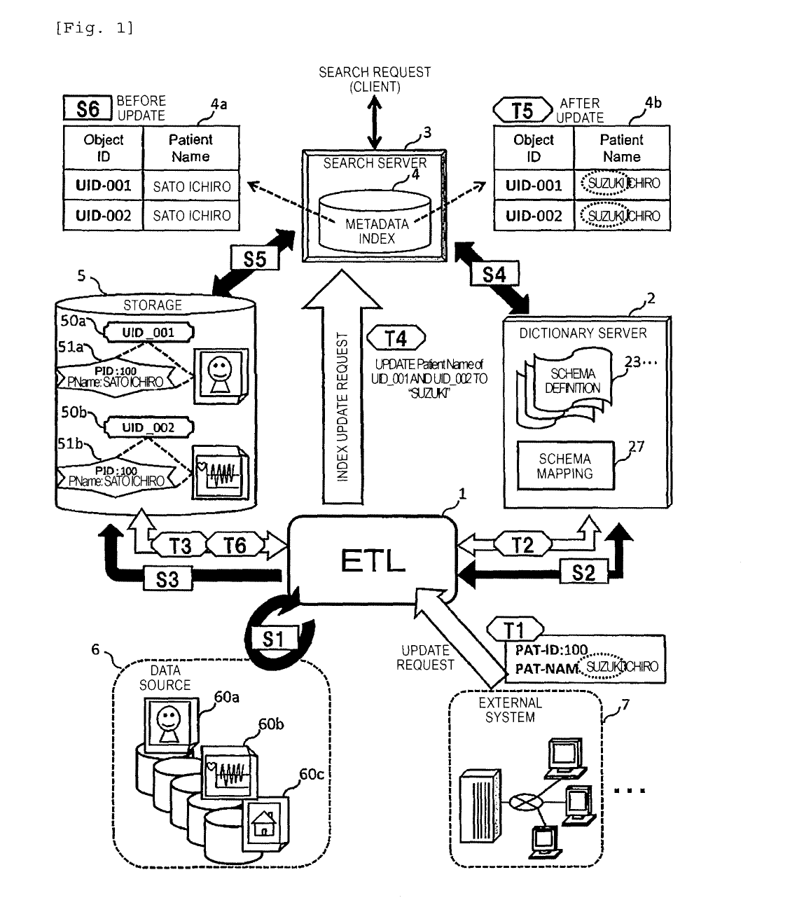

First, a concept of a computer system 100 to which the invention is applied is illustrated in FIG. 1. The data to be processed in the computer system in the recent years has various types of data formats such as structured data, semi-structured data, and unstructured data, and requires mass process of the data. The computer system 100 is a system that effectively manages the data by using metadata including attribute of the various types and the large amounts of data. According to the embodiment, a healthcare information system which is one of the specific application examples of the computer system 100 is described as an example.

For example, in the field of the healthcare information system, independent systems in various fields having different data formats such as a search request source, a data source 6, and an external system 7 increase, so data sharing among the environments is desirable. For example, when a patient who receives a first opinion in an A hospital receives a second opinion in a B hospital, if A and B have different data formats (schema or the like), the difference hinders the sharing. As healthcare services are specialized and classifications are subdivided, systems of the respective facilities may become complicated and massive modularity structures. One of the characteristics of the computer system 100 is managing data of the respective systems in an integrated manner without revising the system of the data sharing source.

The computer system 100 includes an ETL 1, a dictionary server 2, a search server 3, and a storage subsystem 5. In the computer system 100, image data and attribute information thereof are collected from the data source 6 (including computer system with server, storage, and the like) in which image data such as X ray images of patients is maintained, via a communication line and a metadata index 4 for searching is created by processing the image data and the attribute information. The metadata index 4 is searched in response to the search request from a client (for example, operation terminals of healthcare facilities), and the response is performed with the request data based on the result. For example, in the ETL 1, the image data from the data source 6 is collected, and the collected image data is transformed to a predetermined data format and stored in the storage subsystem 5. In the search server 3, the metadata of the data stored in the storage subsystem 5 is crawled in a predetermined chance so as to generate the metadata index 4 for searching. In this manner, data propagation from the data source 6 to the search server 3 or the like is periodically (or arbitrarily) repeated so that data pool is provided to the client.

Further, in the computer system 100, an update request of the attribute information (metadata) of the image data is received from the external system 7 such as a healthcare information system which is a control system independent from the main system.

In addition, schemas of the image data maintained in the data source 6, the data included in the metadata update request from the external system 7, and also the data used in the respective servers or the storage subsystem configuring the computer system 100 are different from each other. Therefore, in the computer system 100, the data having different schemas is transformed to schema formats used in the respective subsystems, so that data propagation is performed. First, a data collection and index generation process (S1 to S6) is described, and thereafter a metadata update process (T1 to T6) is described.

In the ETL 1, the schema mapping 27 generated by associating various schema definitions 23 with the dictionary server 2 can be maintained. In the ETL 1, with respect to the associated data, correspondence relationship of the schemas in the respective servers and the storage subsystem are managed by using the schema mapping 27. Particularly, in the ETL 1, performing schema transformation of the acquired data by using the schema mapping, attaching common unified IDs to the transformed data in a computer system 1, and performing data transmission and reception with the search server 3 or the storage subsystem 5 is one of the characteristics.

In addition, in the process such as the schema transformation, the schema mapping may be dynamically generated from the schema definition 23, or may be statically maintained by the setting by the user, in advance. According to the embodiment, the schema mapping is described by dynamic generation.

The ETL 1 acquires image data 60a to 60c maintained in the data source 6 in a predetermined chance (periodically or according to the instruction from the outside) (S1). The acquisition may be collection (crawling) of the image data 60a from the ETL 1 or output (push) from the data source 6. According to the embodiment, the acquisition is described as crawling.

The attribute information such as a patient's ID attached to image data in the data source 6 is different from the schema of the computer system 100. Here, the ETL 1 acquires the schema mapping 27 of the dictionary server 2, the schema format of the corresponding image data is specified to the image schema format, and the necessary item is extracted from the attribute information of the image data (S2). For example, “PatientID (patient's ID): 100” and “Patient Name (patient's name): Sato Ichiro” which are items of the image schema format are extracted from the attribute information of the image data 60a in the data source 6.

The ETL 1 refers to the schema mapping 27, transforms the extracted items to a format of the unified schema definition, which is a schema format used in the storage subsystem 5, and also assigns a unified ID 50 to transformed metadata and image data and outputs to the storage subsystem 5 (S3). For example, “PatientID (patient's ID): 100” and “Patient Name (patient's name): Sato Ichiro” in the image schema format extracted from the attribute information of the image data 60a are transformed to “PID (patient's ID): 100” and “PName (patient's name): Sato Ichiro” which are in the unified schema format so that “UID_001” can be assigned as a unified ID 50a, and metadata 51a and the image data 60a are associated and stored in the storage subsystem 5.

The search server 3 requests the generation of the schema mapping from the dictionary server 2, and acquires schema mapping of the unified schema and the search index schema from the dictionary server 2 (S4).

Thereafter, the search server 3 acquires (crawls, or the like) the metadata 51a and 51b and the unified IDs 50a and 50b corresponding thereto from the storage subsystem 5 at a predetermined chance (fixed update time or the like) (S5), and generates a metadata index 4a based on the schema mapping acquired in S4. In the metadata index 4a, a unified ID “Object ID=UID-001” and a patient's name “patient's ID=Sato Ichiro” are associated.

Subsequently, a metadata update process (T1 to T6) which is one of the other characteristics according to the embodiment is described. For example, the name of the patient may be changed afterward due to marriage, a name change, or the like. When the name or the like is changed, if the client performs the search request with the patient's name after the change, there is a concern that the image data with the metadata before the change may not be acquired. Also, in the computer system 100, in response to the metadata update request from the external system 7, the schema format of the search server 3 which is an update target system from the ETL 1 is dynamically designated to perform the update request.

First, an update request for changing the name of the patient or the like is transmitted from the external system 7 to the ETL 1 (T1). The update request is to set the name after the change to be “PAT-NAME: Suzuki Ichiro” with respect to “PAT-ID: 100” of which the name before the change is “Sato”. In the external system 7, the data is dealt with the schema in which the ID of the patient is “PAT-ID” and the name of the patient is “PAT-NAME”. That is, the data in a fourth schema format which is different from the schema used in the search server 3, the storage subsystem 5, and the data source 6.

With respect to this, the ETL 1 specifies another schema format identical to the schema item included in the update request based on the schema mapping 27 acquired from the dictionary server 2 (T2). For example, among the schema items included in the update request, the schema item of the unified metadata corresponding to “PAT-ID” is “PID”. Also, the value “100” of the “PID” (“PID: 100”) is specified as a schema key (T2).

The ETL 1 requests the storage subsystem 5 to search “PID: 100” as a schema key, and if the corresponding metadata is searched, the unified ID 50 associated with the corresponding metadata is transmitted to the ETL 1 (T3). For example, the unified ID 50a and the unified ID 50b are acquired by the ETL 1.

The ETL 1 causes an update instruction message to include an update target item transformed to the item name in the schema format of the search server 3 and the updated value together with the unified IDs 50a and 50b, and transmits the update instruction of the metadata index to the search server 3 (T4). For example, with respect to the “unified ID=UID_001, UID_002”, a request for an update to “Patient Name=Suzuki Ichiro” is transmitted.

The search server 3 receiving the update request updates the value of “Patient Name” of the index having a unified ID corresponding to the metadata index 4 to “Suzuki Ichiro” (T5).

Thereafter, the ETL 1 transmits a request for updating the values of the metadata 51a and 51b of which the unified IDs are UID_001 and UID_002 stored in the storage subsystem 5 to the storage subsystem 5 (updating PName to “Suzuki”) (T6).

The above is the concept of the computer system 1.

In this manner, the computer system 100 can provide a sharing interface of the data having different schemas in a system with a modularity configuration in which various schemas are interposed in a complicated manner.

Further, in the computer system 100, when metadata update is received, an update instruction of the metadata index 4 is directly transmitted from the ETL 1 to the search server 3 in addition to the general data propagation course, so it is not necessary to wait for the metadata update of the storage subsystem 5 when updating the metadata index 4.

Hereinafter, the computer system 1 is described in detail.

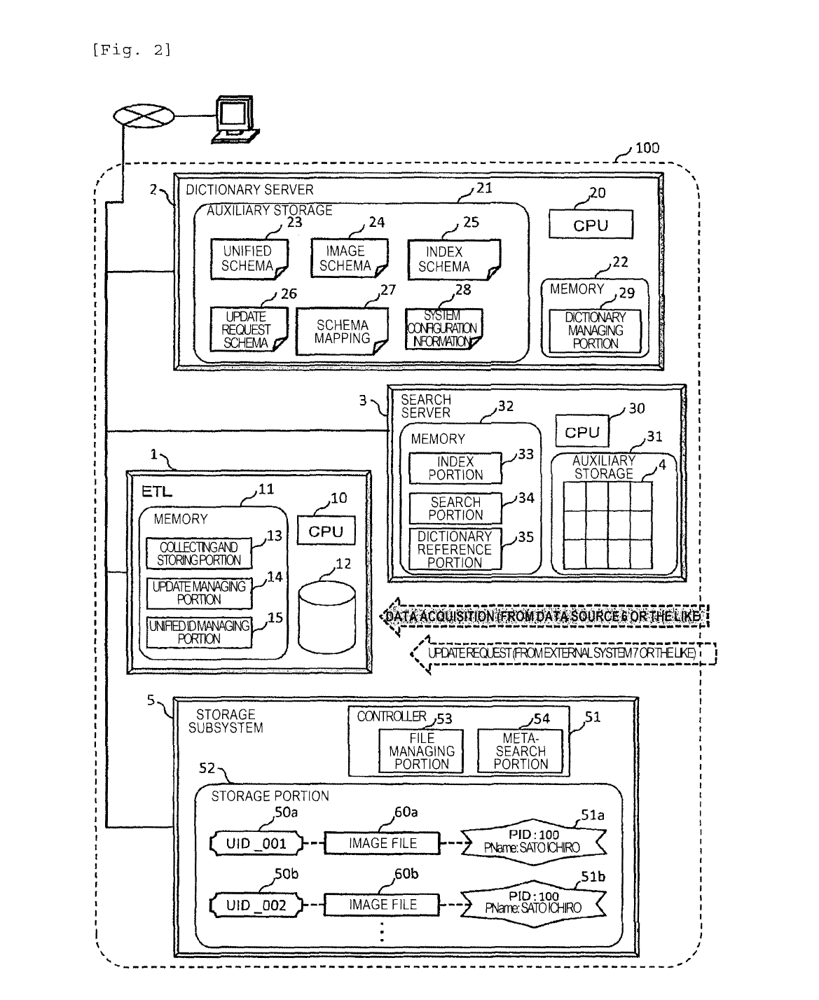

FIG. 2 is a diagram schematically illustrating a configuration of the computer system 100 according to the first embodiment. The computer system 100 has the ETL 1, the dictionary server 2, the search server 3, and the storage subsystem 5, and is connected to wired or wireless communication lines (including PCI bus, LAN, WAN, and the Internet) so that data communication can be performed. The computer system 100 further connected to the external data source 6 or the external system 7 so that data transmission and reception can be performed, and receives request for collecting and updating data. The computer system 100 processes the data acquired from the data source 6 and the like so as to be function as a search data source, and reply to the various search request from the client.

According to the embodiment, an example in which the respective servers or the respective subsystems are configured as an independent physical computer is described, but a portion or all of the servers or the subsystems may be installed in a single physical computer, and may be configured as logically different computers by a virtual computer or the like. Further, according to the embodiment, an example in which functions of the various servers are realized by the cooperation of programs and a CPU is described, but a portion thereof may be configured as hardware.

A general purpose server device having a CPU 10, a main memory 11, and an auxiliary storage 12 is applied to the ETL 1. In the ETL 1, a collecting and storing portion 13, an update managing portion 14, and a unified ID managing portion 15 are realized in cooperation with the programs and the CPU 10 to extract, transform, and load data.

Specifically, in the collecting and storing portion 13, crawling of the image data is performed at a predetermined chance (periodically or arbitrarily) from the data source 6 that stores healthcare images such as the X rays or MRI images of patients, so that attribute information such as the patient's IDs, the patient's names, the image generation date and time, and the description of the images accompanied by the image data is extracted. The extracted attribute information is processed (transformed) as metadata appropriate for the unified schema definition 23 of the storage subsystem 5 by using the schema mapping 27 described below.

In the unified ID managing portion 15, the unified ID 50 is issued to the metadata processed to the unified schema definition 23 and the image data. Thereafter, the unified ID 50, the metadata, and the image data transmitted to the storage subsystem 5 are stored in the storage subsystem 5 in an associated manner.

In the update managing portion 14, with respect to the metadata of the data stored in the storage subsystem 5 in advance, if the update request is received from the external system 7, the update request of the metadata index corresponding to the metadata which is the update target is issued by the search server 3, and the metadata of the update target of the storage subsystem 5 is updated. More specifically, in the update managing portion 14, the metadata of the update target from the schema of the data included in the update request from the external system 7 is specified by the schema mapping 27, to specify the schema key for extracting the target data from the metadata in the storage subsystem 5. The metadata of the storage subsystem 5 is searched by using the schema key, and the unified ID (UID) 50 of the corresponding updating target data is acquired. Thereafter, in the update managing portion 14, the acquired unified ID (UID) 50 and a value to be updated are designated so that the update instruction of the metadata index 4 is output to the search server 3.

In addition, in the update managing portion 14, in response to the update request from the external system 7, sends a response according to a progress status of an update process of the metadata index 4 of the search server 3 or a metadata update process of the storage subsystem 5. For example, when anyone of update processes is completed, a response of “update completion” is sent, when a index update process on one side (for example, the metadata index 4) is completed and a metadata update process on the other side (for example, the storage subsystem 5) is in progress on the background, a response of “partial update completion” is sent, and when a schema change process of the metadata index 4 is in progress, a response of “update process is not acceptable” indicating temporary interruption of an additional update request is sent.

A general purpose server device having a CPU 20, a memory 22, and an auxiliary storage 21 is applied to the dictionary server 2. In the memory 22 of the dictionary server 2, a dictionary managing portion 29 is realized by the cooperation of the CPU 20 and the programs. To the dictionary managing portion 29, the schema definitions 23 to 27 are transmitted in response to the request from the ETL 1 or the search server 3, or the schema mapping 27 indicating the response between the corresponding schema definitions is generated or transmitted.

The unified schema 23, the healthcare image schema 24, the index schema 25, and the update request schema 26 which indicate schema definitions of the metadata used in the respective servers or the storage subsystem configuring the computer system 100, the schema mapping 27 indicating the correspondence of the definitions, and the system configuration information are stored in the auxiliary storage 21 of the dictionary server 2. The schemas of the metadata handled in the respective servers or the storage subsystem are different from each other, and in the computer system 100, that the data having different schema formats are propagated by using schema mapping is one of the characteristics.

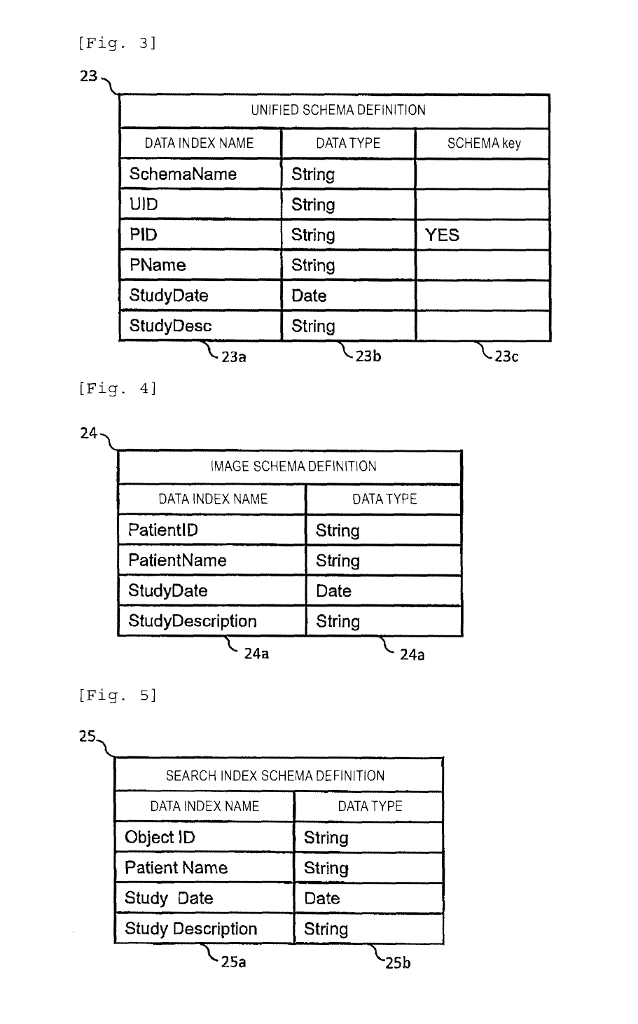

FIG. 3 is a diagram schematically illustrating the unified schema definition 23. The unified schema definition is defined by associating data item names 23a, data types 23, and schema keys 23c indicating the designation whether the respective items are schema keys. “SchemaName” in the data item name 23a indicates a name of the schema, “UID (Unified identifier)” indicates the “unified ID” commonly used in the server or the storage subsystem that configures the computer system 100. “PID (Patient identifier)” indicates an ID of a patient, and “PName” indicates a name of the patient. “StudyDate” indicates an image photographed date or an examination date, and “StudyDescription” indicates a supplementary item including a kind of the photographed image (X ray image of chest, MRI image of head, electrocardiogram, or the like). In the data type 23, data types such as Storing or Data are defined.

In the update process of the metadata index 4 of the search server 3 described below, the schema key 23c is the information for designating the data item that becomes a key when the ETL 1 searches the metadata of the update target from the storage subsystem 5. In FIG. 3, an example in which “PID” is designated as a key for searching the updating target data is illustrated.

FIG. 4 is a diagram schematically illustrating the image schema definition 24. The schema definition is used when the ETL 1 collects image data or the like from the data source 6, transforms the collected image data into a schema format of the unified schema definition 23 used in the storage subsystem. The patient's ID or the patient's name are defined in the same manner as in the unified schema definition 23, but as indicated by a data item 24a, the respective item names may be the same meaning as the indicated contents as in “PatientID” or “Patient Name”, and may be item names in a format different from the other.

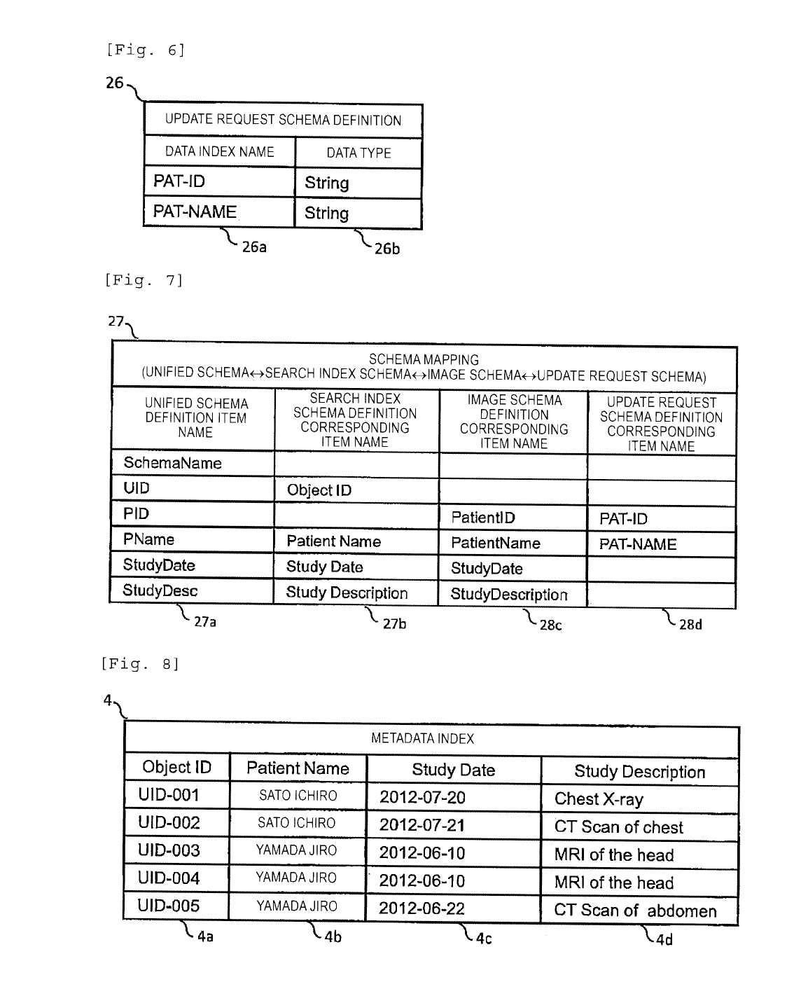

FIG. 5 is a diagram schematically indicating search index schema definition information 25. The schema definition is used when the search server 3 reads the metadata stored in the storage subsystem 5 and generates the metadata index. In the same manner as in the unified schema definition 23 or the image schema definition 24, the respective item names may be the same as the same meaning as the indicated contents, and may be item names in a format different from the other schema.

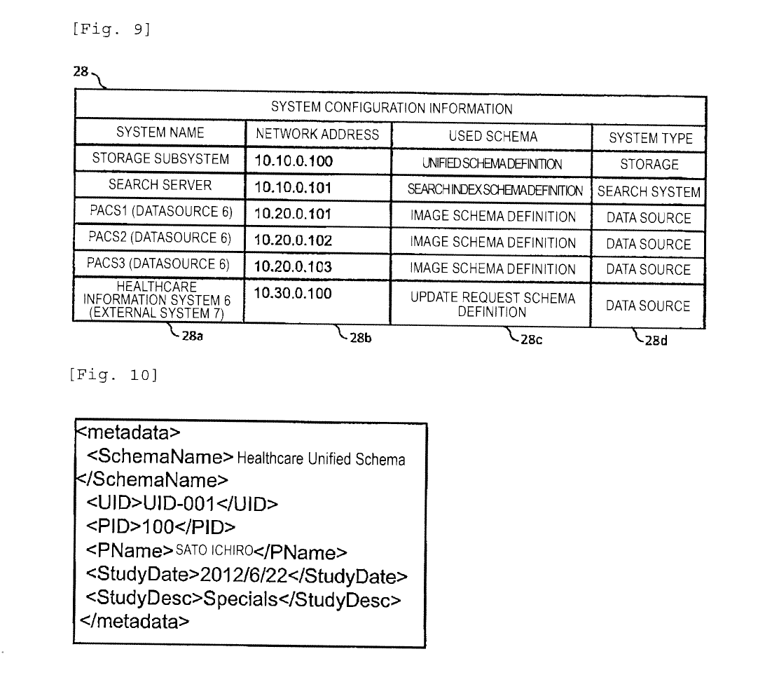

FIG. 6 is a diagram schematically indicating the update request schema definition 26. The schema definition is used when the update request of the metadata such as a patient's ID or a patient's name is received from the external system 7. In the same manner as in the other definition, the respective item names may be the same as the same meaning as the indicated contents, and may be item names in a format different from the other schema.

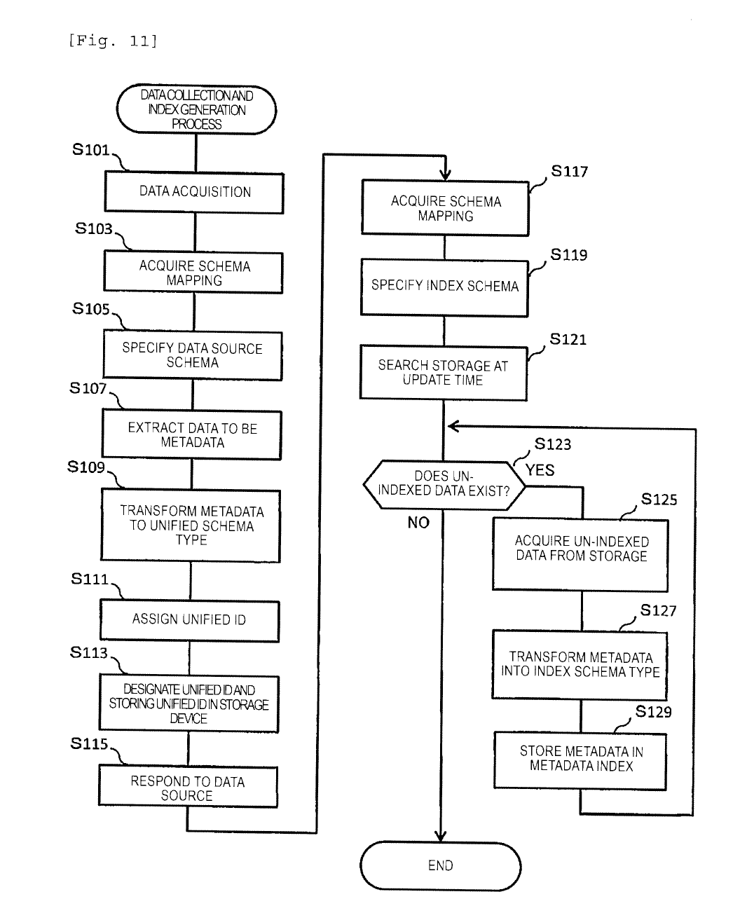

FIG. 7 is a diagram schematically illustrating the schema mapping 27 indicating a correspondence relation between the various schema definitions illustrated in FIGS. 3 to 6. For example, the item “UID” of the unified schema definition 23 indicates the correspondence to “ObjectID” of the search index schema definition 25. In the same manner, “PName” of the unified schema definition 23 indicates the correspondence to “Patient Name” of the search index schema definition, and “Patient Name” of the image schema definition 24 indicates the correspondence to “PAT-NAME” of the update request schema 26.

In addition, the dictionary server 2 receives acquisition request of the schema definition or generation and acquisition requests of the schema mapping from the ETL 1, the search server 3, or the like, but the selection of the combination of the schema definition or the schema mapping corresponding to the request is performed by using system configuration information 28.

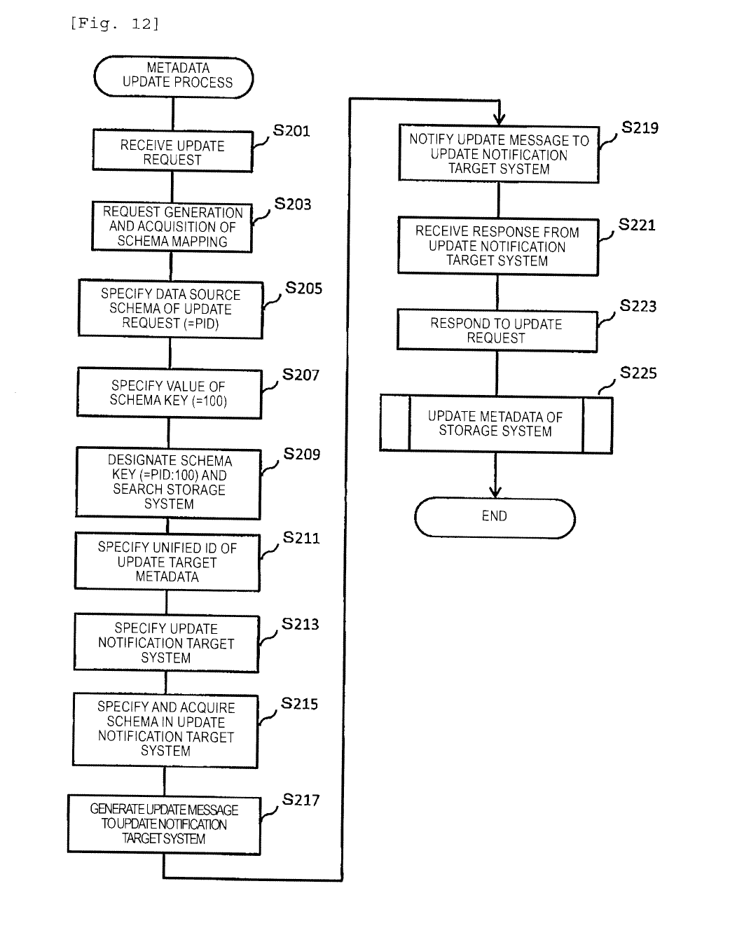

FIG. 9 is a diagram schematically illustrating an example of the system configuration information 28. In the system configuration information 28, a system name 28a, a network address 28b of a request target system of a schema definition or the like, a schema used in the request target system, and a system type 28d are managed in an associated manner. For example, in the ETL 1, if the schema transformation on the attribute information of the image data collected from the data source 6 (indicated by PACS1 to PACS3 in FIG. 9) is performed, the network address of the data source 6 which is a collection source and a network address of the storage subsystem 5 which is an output target are notified to the dictionary server 2 in response to the generation and acquisition request of the schema mapping 27.

In the dictionary server 2, with reference to the system configuration information 28, the schema mapping 27 is generated from respective schema definitions (the unified schema definition 23 and the image schema definition 24) corresponding to both network addresses included in the notification and output to the ETL 1.

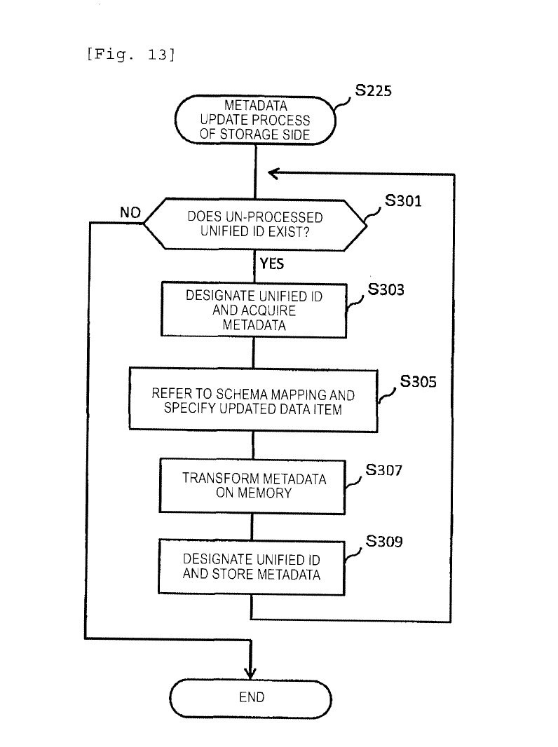

FIG. 10 is a diagram illustrating the metadata 51a which is transformed to a format of the unified schema definition by using the schema mapping 27 and associated with the unified ID (UID 50a). An “unified schema” is described as “SchemaName”, “001” is described as “UID (unified ID)”, “100” is described as “PID (patient's ID)”, “Sato Ichiro” is described as “PName (patient's name)”, “2012/6/22” is described as “StudyDate (image photographed date)”, and “Specials (supplementary or the like)” is described as “StudyDesc (kind of image/remark)”

The description returns to FIG. 2, a general purpose server device having a CPU 30, a memory 32, and an auxiliary storage 31 is applied to the search server 3. In the memory 32 of the search server 3, an index portion 33, a search portion 34, and a dictionary reference portion 35 are realized in the cooperation of the CPU 30 and the programs. In addition, the metadata index 4 which is an index for a metadata search request from the client or the like is stored in the auxiliary storage 31.

In the search server 3, the metadata index 4 for searching is generated by acquiring the metadata stored in the storage subsystem at a predetermined chance (periodically or arbitrarily) and using the schema mapping 27. Also, if an update is generated in the content of the metadata from the external system 7, a metadata index is updated in response to the metadata index update instruction from the ETL 1.

In the index portion 33, with reference to the schema mapping 27 indicating the correspondence of the unified schema definition and the search index schema definition acquired from the dictionary server 2, the metadata index 4 is generated from the metadata acquired from the storage subsystem 5. In addition, in the index portion 33, when the update instruction of the metadata index 4 is received from the ETL 1, the metadata index of the update target is updated. Update examples of the metadata index include a case in which the first name of a patient is changed due to marriage or a name change.

In the dictionary reference portion 35, when the metadata index 4 is generated, the generation and acquisition request of the schema mapping is performed on the dictionary server 2.

FIG. 8 is a diagram schematically illustrating an example of the metadata index 4. In the metadata index 4, the unified IDs (UID) 50 are registered in the “Object ID” section 4a, names of patients such as Suzuki Ichiro or Yamada Jiro are registered in the “Patient Name” section 4b, image photographed dates or examination date are registered in the “Study Date” section 4c, and descriptions relating to the photographed image or the like (X ray image of chest, CT scan image of chest, and MRI image of head) are registered in the “Study Description” section 4d.

In the search server 3, if items corresponding to the keyword included in the metadata search request from the client or the like are searched in the metadata index 4 and there is a corresponding item, reading of the target data in the storage subsystem 5 with the corresponding unified ID (UID) 50 is requested, and the result in response to the request is transmitted to the client.

Accordingly, if the change of the first name of the patient as described above exists in the external system 7, the update of only the metadata of the storage subsystem 5 is completed, and if a search request including a patient's name “after” the change as a search key is received from the client before the update of the metadata index 4 is completed, there is no hit keyword in the metadata index 4 so that the image data of the original first name may not be provided to the client.

Therefore, in the computer system 100, since the metadata index 4 is updated early when the metadata update request is performed and the reading request of the actual data of the search target to the storage subsystem is performed by using the common unified IDs (UID) 50 in the system, there is an advantage in that flexibly respond to the request of the client who frequently requests the information update.

The file storage device that stores an image data in a file format and metadata is applied to the storage subsystem 5. A controller 51 having a processing unit, a memory, a data cache, or the like is provided in the storage subsystem 5. A file managing portion 53 that provides an input/output control of a file or a file interface and a meta-search portion 54 that returns the unified ID (UID) 50 corresponding to the corresponding metadata based on the designated schema name and the designated schema key at the time of the metadata update request process from the ETL 1 are provided in the controller 51. A portion thereof may be configured as hardware, but the embodiment is described by using an example in which it is realized by the cooperation of the processing unit and the programs.

Plural magnetic recording media such as HDD or plural electronic recording media such as SSD or a flash memory are provided in a storage portion 52. In the storage portion 52, metadata 51 transformed in a unified schema format by the ETL 1 and image data 60 are stored in an associated with the unified ID (UID) 50. In an example of FIG. 2 described above, an aspect in which the metadata 51a of “PName: Sato Ichiro” in “PID: 100” as attribute information of the image file 60a is stored in an associated manner with the unified ID 51a of “UID_001” is described.

Lastly, the configuration of the data source 6 is described. A storage server system in which a massive image data storage is assumed is applied to the data source 6. According to the embodiment, the healthcare image data is maintained in a data format conforming to PACS (Picture Archiving and communication system) by a storage server, for example, conforming to the DICOM standard. Since the communication in the DICOM standard is appropriate for achieving the image data from modality (healthcare device such as CT or MRI) and the stored data amount is also massive, the communication in the DICOM standard is generally used as a database for healthcare services.

However, in the DICOM standard, attribute information attached to each image data has a unique format, and there is a problem in that the data is shared in systems having different data formats and there is an issue of sharing data indifferent systems. According to the embodiment, since the ETL 1 dynamically performs the schema transformation of the attribute information, there is an advantage in that a database having an excellent data amount can be easily used. In addition, it is obvious that other archive storage or the like can be applied.

The above is the configuration of the computer system.

Subsequently, a flow of the process of the computer system is described. In addition, in the description below, the flow is described by dividing the flow into (1) a flow of the process from the data source 6 to “the collection and process of the data and the generation of the metadata index” (S1 to S6 in FIG. 1) and (2) a flow of the process of “update process of the metadata and the metadata index” when the metadata update request is received from the external system (T1 to T6 of FIG. 1).

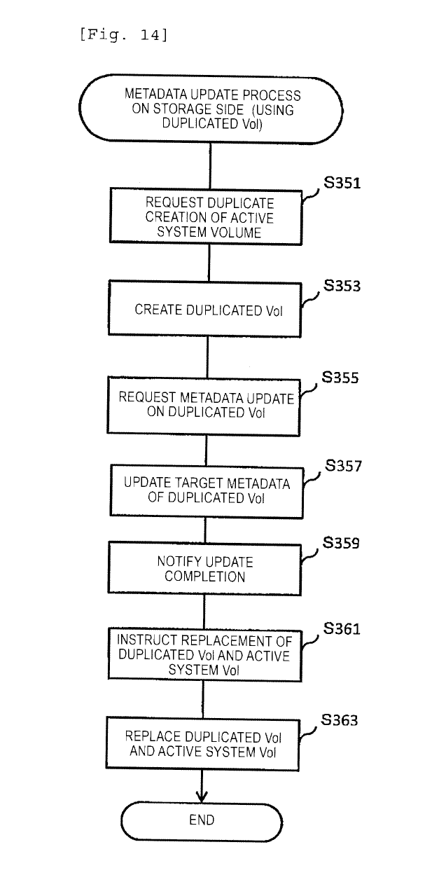

FIG. 11 is a flow chart illustrating a flow of a “data collecting and metadata index generating process”.

In S101, the collecting and storing portion 13 of the ETL 1 acquires the image data 60a from the data source 6 at a predetermined chance (periodically or arbitrarily).

In S103, the collecting and storing portion 13 designates the data source 6 which is the data acquisition source and the network address of a storage subsystem which is a data storage target, and transmits a generation and acquisition request of the schema mapping to the dictionary server 2.

In S105, the dictionary managing portion of the dictionary server 2 receives a request, refers to the system configuration information 28, specifies the combination of the schema definition corresponding to the network address included in the request, and generates the schema mapping 27. Also, the generated schema mapping 27 is sent to the ETL 1 as a response.

In S107, the collecting and storing portion 13 of the ETL 1 extracts the attribute information included in the image data 60a, 60b, and the like acquired from the data source 6.

Also, in S109, the collecting and storing portion 13 refers to the schema mapping 27, and generates the metadata 51a, 51b, and the like in which the extracted attribute information is transformed to the unified schema definition format.

In S111, the unified ID managing portion 15 issues the unified IDs 50a, 50b, and the like, and assigns the unified IDs to the image data 60a, 60b, and the like and the metadata 51a, 51b, and the like.

In S113, the collecting and storing portion 13 outputs the image data 60a, and the like, and the metadata 51a, and the like with write request which specifies the assigned unified IDs to the storage subsystem 5.

Also, in S115, the collecting and storing portion 13 outputs the completion notification of data acquisition to the data source 6.

In this manner, the search server 3 performs the metadata index generation process on the metadata group stored in the storage subsystem 5.

In S117, the dictionary reference portion 35 of the search server 3 designates the storage subsystem 5 which is an acquisition source of the metadata and the network address of the search server 3 and transmits the generation and acquisition request of the schema mapping 27 to the dictionary server 2.

In S119, in the same manner as in S105, the dictionary managing portion 29 of the dictionary server 2 refers to the system configuration information 28, designates the combination of the schema definitions that become schema mapping targets based on the network addresses, and generates the schema mapping 27 (herein, the unified schema definition 23 and the search index schema definition 25 are mapped). Also, the dictionary managing portion 29 of the dictionary server 2 sends the generated schema mapping 27 to the search server 3 as a response.

In addition, the combination of the schema definition may be performed so as to specify the corresponding index schemas from the schema names included in the metadata.

In S121, the index portion 33 of the search server 3 acquires the metadata group from the storage subsystem 5 at a predetermined chance which is predetermined by a scheduler or the like. It is preferred that the chance is before a next data storing process from the ETL 1 to the storage subsystem is started, and the timing is right after a previous data storing process is completed. This is because the timing is in the state in which the stored data source can be searched more quickly.

In S123, the index portion 33 checks whether there is metadata in an un-indexed state which becomes an index target in the storage subsystem 5, and if there is no metadata (S123: No), the process ends, and if there is metadata (S123: Yes), the process proceeds to S125.

In S125, the index portion 33 acquires the un-indexed metadata from the storage subsystem.

In S127, the index portion 33 refers to the schema mapping 27, transforms the metadata in the unified schema format to the search index schema format and registers the metadata to the metadata index 4 in S129, and the process returns to S123.

The above is the data collection and index generation process.

Subsequently, the “metadata update process” in which the metadata of the update target and the metadata index 4 corresponding thereto are updated when the update request of the metadata is generated from the external system 7 is described. FIG. 12 is a flow chart illustrating the “metadata update process”.

In S201, the update managing portion 14 of the ETL 1 receives a metadata update request for updating “PAT-NAME (patient's name)” of “PAT-ID (patient's ID): 100” from the external system 7 (from formerly “Sato Ichiro”) to “Suzuki Ichiro”.

In S203, the update managing portion 14 designates a network address of the external system 7 which is an update request source, a network address of a storage subsystem, and a network address of the search server 3, and transmits a generation and acquisition request of the schema mapping to the dictionary server 2.

In S205, the dictionary managing portion of the dictionary server 2 refers to the system configuration information 28, and specifies corresponding schema definitions for respective three addresses designated by the generation and acquisition request of the schema mapping. Also, the schema mapping 27 is generated from the specified update request schema definition 26, the unified schema definition 23, and the search index schema definition 25, and is sent to the ETL 1 as a response.

In S209, the update managing portion 14 of the ETL 1 refers to the schema mapping 27, extracts the unified schema item name corresponding to the “PAT-ID” that is designated as an update target in the update request of the external system 7, and adds a value of “100” which is an actual identification information of “PAT-ID” to the unified schema item name to be specified as the schema key. As indicated as in the example of the schema mapping in FIG. 7, the item name of the unified schema definition corresponding to the “PAT-ID” of the update request schema definition is “PID”. Accordingly, the “PID: 100” is specified as the schema key.

In S211, the update managing portion 14 designates the kind of the schema definition and the schema key, performs searches on the metadata of the storage subsystem 5, and acquires the unified ID of the metadata corresponding to the schema key. For example, in the case of the present embodiment, among the metadata stored in the storage subsystem 5, the metadata having the schema key “PID: 100” is 51a and 51b. Accordingly, the update managing portion 14 extracts and specify the unified ID 50a (“UID_001”) and the unified ID 50b (“UID_002”) from the metadata (see FIG. 7).

In S213, the update managing portion 14 refers to the system configuration information 28, and specifies the server which is an update notification target. According to the present embodiment, in the system registered to the system configuration information 28, the search server 3 of which the system type is “search system” is specified as the update target.

In S215, the update managing portion 14 refers to the schema mapping 27, specifies schema definition (the search index schema definition 25) used in the search server 3 which is the update notification target, and acquires the search index schema definition 25 from the dictionary server.

In S217, the update managing portion 14 refers to the search index schema definition 25, and generates the message of the metadata index update instruction to the search server 3. Specifically, the item name and the value of the update target included in the metadata update request from the external system 7 (“PAT-NAME: Suzuki Ichiro”) is transformed to “Patient Name: Suzuki Ichiro” which is the search index schema format. Also, an update instruction message in which the unified IDs 50a and 50b (“UID_001” and “UID_002”) specified in S211 are added is generated.

In S219, the update managing portion 14 transmits the update instruction message to the search server 3. In the index portion 33 of the search server 3 which receives the message, the metadata index 4 (FIG. 8) is searched with the unified IDs in the message, the update target metadata index is specified, and the corresponding “Patient Name” is updated to “Suzuki Ichiro” (formerly “Sato” is updated to “Suzuki”). After the completion of the update, the search server 3 notifies the fact to the update managing portion 14 of the ETL 1.

In S221, the update managing portion 14 of the ETL 1 receives a response of the update completion from the search server 3, notifies the update completion to the external system 7 in 5223, and completes the update process of the metadata index 4. In addition, the response to the external system 7 is not limited to “update completion”, and may include “partial update completion”, “update process is not acceptable”, and the like, as described above.

Thereafter, in S225, the update managing portion 14 performs an update process of the metadata stored in the storage subsystem 5.

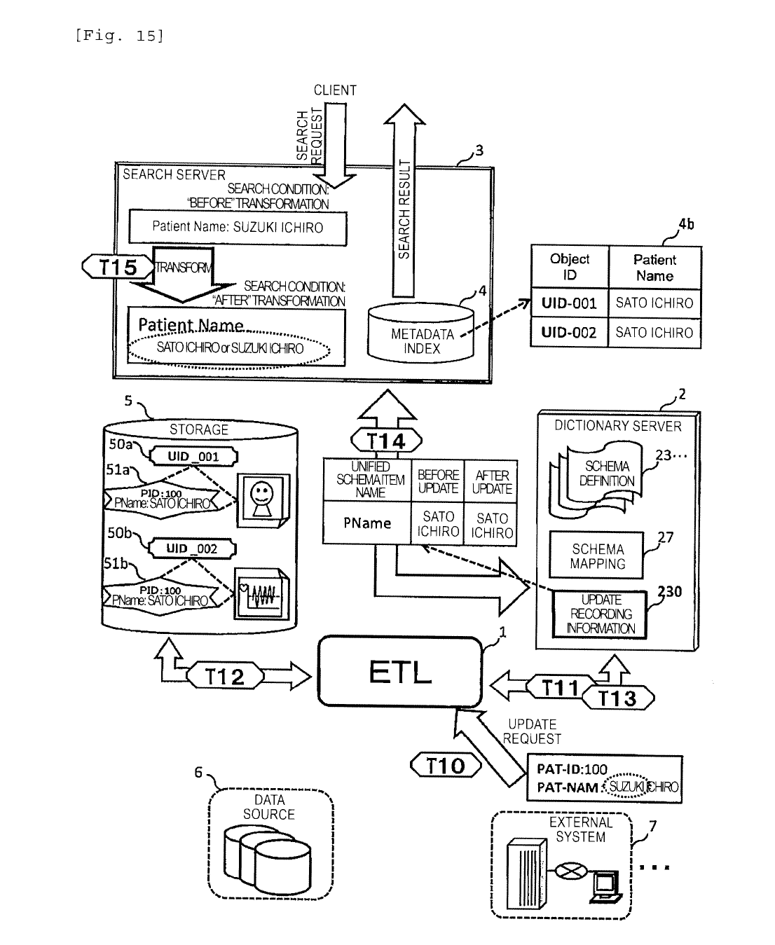

FIG. 13 is a flow chart illustrating a flow of the update process of the metadata stored in the storage subsystem 5.

In S301, the update managing portion 14 of the ETL 1 checks whether the metadata update is performed on the unified IDs 50a and 50b acquired in S211 of the metadata index update process described above. If the un-processed unified ID 50 does not exist (S301: No.), the process is completed, and if the un-processed unified ID 50 exists (S301: Yes), the process proceeds to S303.

In S303, the update managing portion 14 acquires the metadata corresponding to the un-process unified ID 50 of the storage subsystem 5. Specifically, the meta-search portion 54 of the storage subsystem 5 searches the data stored in the storage portion 52 based on the designated unified ID 50, and outputs the metadata corresponding to the unified ID to the ETL 1.

In S305, the update managing portion 14 refers to the schema mapping 27, and specifies the update target item included in the update request of the external system 7. The item name “PAT-NAME” indicating the update request target is “PName” in the metadata described in the unified schema format. Accordingly, in 5307, the update managing portion 14 updates the value of the item name “PName” on the metadata from “Sato Ichiro” to “Suzuki Ichiro”.

In S309, the update managing portion 14 designates the unified ID and stores the metadata after update to the storage subsystem 5. Thereafter, the process returns to the process of S301.

The above is the update process of the metadata index and the storage subsystem of the metadata update process.

According to the computer system of the embodiment, since the ETL 1 performs the update instruction of the metadata index 4 directly on the search server 3 in response to the metadata update request, an early update of the index can be performed without waiting for the metadata update of the storage subsystem 5.

That is, the metadata index 4 can perform incremental update by causing the search server 3 to crawl metadata again after the metadata update is completed in the storage subsystem, but crawling may not be performed in the metadata update on the storage subsystem side, and even if the crawling can be performed, there is a problem in that the consistency of the data before and after the update is not guaranteed. Further, if a massive data is stored in the storage subsystem, various processes including the search process need time accordingly, and if the metadata of the update target is massive, the update needs the time accordingly. This computer system has a prominent effect that can update the metadata index without considering the process time on the storage system side.

In addition, according to this computer system, there is an effect of causing data to be easily shared between systems using different schemas by the schema mapping of the dictionary server 2. In the system having a complicated modularity configuration, since data sharing or expansion becomes easy, to enable the realization of the system configuration having high availability.

In addition, according to this computer system, there is an advantage in that the data management between the subsystems of the server or the storage becomes easy by using a common unified ID in the system for managing the metadata and the metadata index.

The above is the computer system according to the first embodiment.

[Modification example of the first embodiment] In the above, the computer system 100 according to the first embodiment is configured to perform an update process on the actual active system data stored in the subsystem, when the ETL 1 performs metadata update of the storage subsystem 5 (S225 of FIG. 12/FIG. 13).

In the update process of the metadata, the data between the metadata in the subsystem is inconsistent. In this state, if there is an access to a file in the subsystem from the search server 3 or the like which receives the search request from the client, it may be assumed that file data in an inconsistent state can be provided to the client.

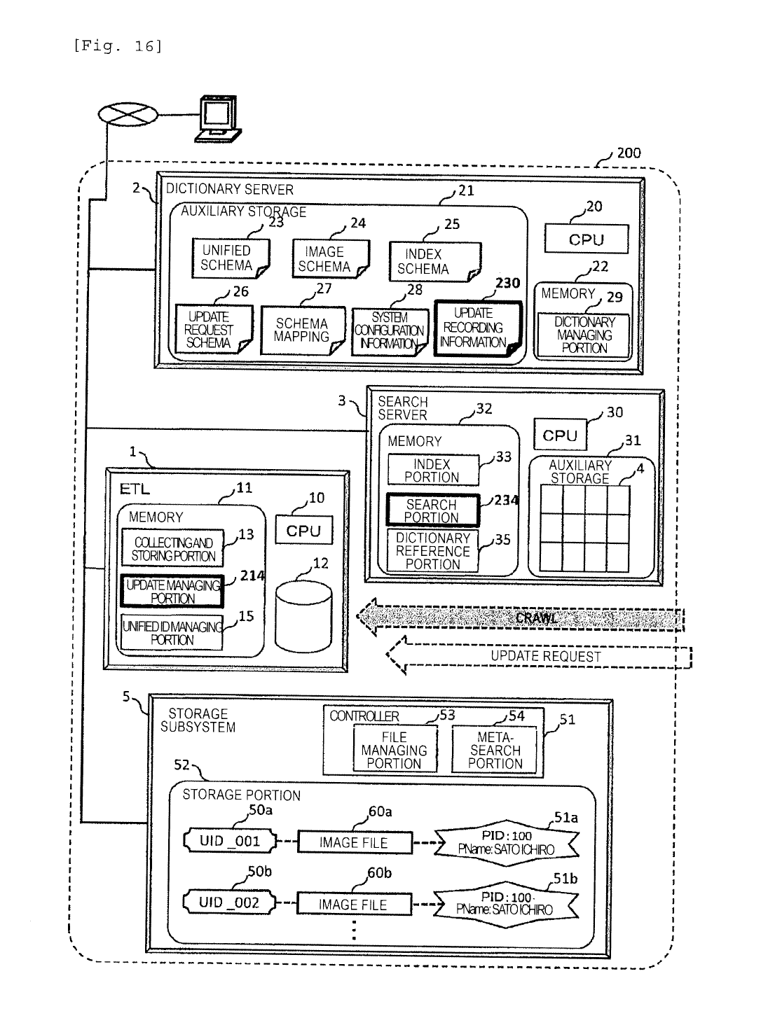

Here, as the modification example of the computer system 100, a configuration example of a computer system 111 that does not present the file data in an inconsistent state to a file access source in the metadata update process of the storage subsystem 5 is described. Specifically, in the computer system in the modification example (hereinafter, referred to as “computer system 111”), the duplication of the storage area (volume) of the active system data in the storage subsystem before metadata update is generated, the metadata update is performed on the duplicate, and the duplicate and the active system volume can be replaced after the update is completed (S225 of FIG. 12 and FIG. 13 become the process of FIG. 14 described below).

The difference from the computer system 100 in the configuration is the update managing portion 14 of the ETL 1. In the modification example, the update managing portion 14 is described as an update managing portion 114 (not illustrated). In addition, the controller 51 of the storage subsystem 5 has a function of managing a volume configuration.

In the update managing portion 114 of the ETL 1, at the time of metadata update of the storage subsystem 5, a creation instruction for duplicating the active system volume is transmitted to a file managing portion 153. In this modification example, a snapshot is used as a duplicate of the volume. Thereafter, in the update managing portion 114, the update instruction is performed to the metadata in the duplicated volume. In the update instruction, in the same manner as in the computer system 100 according to the first embodiment, the unified ID 50 corresponding to the metadata of the update target, the item name transformed to the unified schema format, and the value after the update are included. After all the metadata updates are completed, the update managing portion 114 instructs the replacement of the duplicated volume and the active system volume.

In the controller 51 of the storage subsystem 5, in response to the volume duplicating request and the volume replacement request from the ETL 1, a process of generating the duplicated volume by the snapshot of the active system volume and a replacement process between the active system volume and the duplicated volume is performed.

FIG. 14 is a flow chart illustrating a flow of the metadata update process using the duplicated volume in the computer system 111.

In S351, the update managing portion 114 transmits an instruction for creating a duplicate of the active system volume to the controller 51 of the storage subsystem 5.

In S353, the controller 51 generates a snapshot of the active system volume and creates the duplicated volume.

In S355, the update managing portion 114 transmits the metadata update request including the unified ID 50 corresponding to the metadata of the update target, the item name transformed to the unified schema format, and the value after the update with designating the duplicated volume as a target.

In S357, the file managing portion 53 performs an update of the metadata in the duplicated Vol that becomes the update target, and transmits the update completion notification to the update managing portion 114 in S359.

In S361, the update managing portion 114 transmits the replacement instruction between the duplicated volume and the active system volume.

In S363, the controller 51 performs replacement of using the duplicated volume as an active system volume, and removing the active system volume by that time from the active system.

The above is the metadata update on the storage side using the duplicated volume.

In this manner, according to the computer system 111 in the modification example, the metadata update can be performed without providing a state in which the data in the metadata update is inconsistent to the file access source.

### Second embodiment

The metadata update process according to the first embodiment and the computer system according to the modification example thereof update the metadata index 4 by directly transmitting the data content after update from the ETL 1 to the search server 3 when the update request of the metadata is received from the external system 7.

A computer system 200 according to a second embodiment causes the updated content to the dictionary server 2 to be maintained while the ETL 1 that receives the metadata update request does not perform the metadata update request directly on the search server 3. When the search server 3 receives the search request from the client, based on the updated content maintained in the dictionary server 2, the search server 3 transforms the search condition of the search request to the search condition in which the content after updating is included, and searches the metadata index 4.

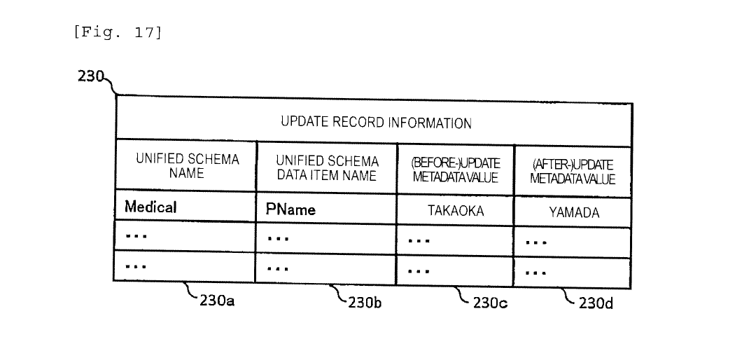

FIG. 15 is a diagram schematically illustrating a process of the computer system 200 according to the second embodiment. In the same manner as in the first embodiment, the computer system 200 collects data from the data source 6, stores the data to the storage subsystem, and generates the metadata index 4 of the search server 3. In this drawing, the metadata update process after the process is already completed is schematically illustrated.

In T10, the ETL 1 receives the update request from the external system 7. The update request is described in the schema format of the external system 7, and is a content of a change request of “PAT-NAME” of “PAT-ID: 100” to “Suzuki Ichiro”.

In T11, the ETL 1 requests the generation and the transmission of the schema mapping 27 to the dictionary server 2. The schema mapping indicates the correspondence between the respective items of the unified schema definition 23 and the update request schema definition 26.

In T12, the ETL 1 specifies the schema key for searching the metadata that becomes the update target from the storage subsystem 5 by using the schema mapping, and acquires the unified ID 50 associated with the update target metadata by using the schema key. The value before update corresponding to the item of the update target (“Sato Ichiro”) is extracted from the acquired metadata. Also, the content of the storage subsystem 5 is updated.

In T13, the ETL 1 transmits and stores the extracted value before update (“Sato Ichiro”), the value after the update included in the update request from the external system 7 (“Suzuki Ichiro”), and “PName” obtained by transforming the item described in the update request schema definition 26 called “PAT-NAME” to the format of the unified schema definition 23 to the dictionary server 2 (hereinafter, the associated information is called “update record information”).

In T14, if the search server 3 receives the search request from the client, the search server 3 acquires the update record information and the schema mapping 27 from the dictionary server 2. The schema mapping 27 indicates the correspondence between respective items of the unified schema 23 and the search index schema 25.

In T15, the search server 3 extracts the search condition “Patient Name: Suzuki Ichiro” from the search request of the client. Further, the “PName” described in the format of the unified schema definition 23 of the update record information 230 is transformed to the “Patient Name” in the format of the search index schema definition 26 by using the mapping table 27. The search server 3 determines whether the search condition “Patient Name: Suzuki Ichiro” of the client is included in the update record information 230 transformed to the format of the search index schema definition 25, and if the search condition is included, the search condition of the client which is transformed to the content of the update record information 230 is newly generated.

Also, according to the search condition after the transformation, the metadata index 4 is searched so that the result is returned to the client.

The above is the concept of the metadata update process in the computer system 200.

FIG. 16 is a diagram illustrating a configuration of the computer system 200 according to the second embodiment. The main difference from the computer system 100 of the first embodiment or the like is the functions of an update managing portion 214 of the ETL 1, communication record information 230 of the dictionary server 2, and a search portion 234 of the search server 3.

In the update managing portion 214, the schema mapping 27 is acquired according to the metadata update request of the external system 7. Thereafter, the item name of the metadata of the transformation target is transformed to the format of the unified schema definition 23 based thereon, and stored in the dictionary server 2 together with the updated value and the value before the update.

The schema mapping 27 acquired from the dictionary server 2 indicates correspondence between the respective items of the unified schema definition 23 (schema format used in the storage subsystem 5) and the update request schema definition 26 (schema format used in the external system 7). Information indicating “PAT-NAME” of “PAT-ID: 100” is changed from “Sato Ichiro” to “Suzuki Ichiro” is included in the metadata update request from the external system 7. In the update managing portion 214, “PAT-NAME: Suzuki Ichiro” is transformed to “PName: Sato Ichiro or Suzuki Ichiro” in the unified schema format, and stored in the dictionary server 2 as the update record information 230.

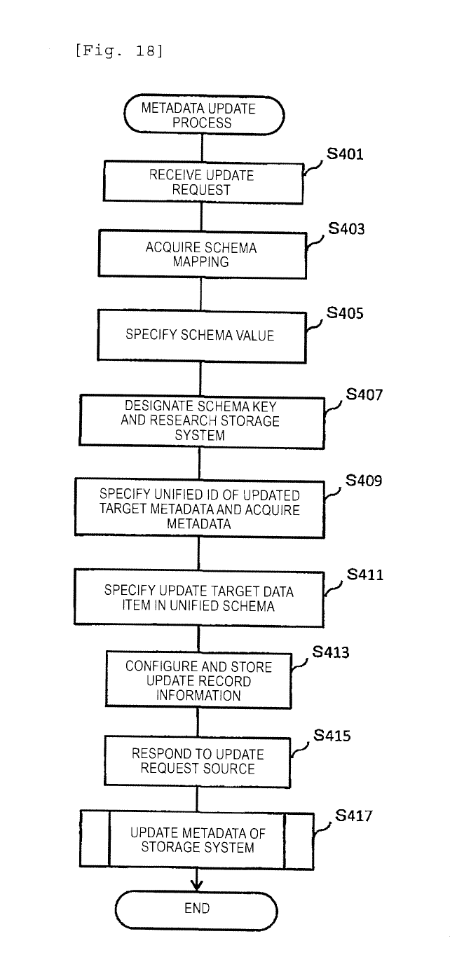

FIG. 17 is a diagram schematically indicating an example of the update record information 230. In the update record information 230, unified schema name information 230a (“Medical”), unified schema item name information 230b (“PName”), before-update metadata value information 230c (“Sato Ichiro”), and after-update metadata information 230d (“Suzuki Ichiro”) are included and managed in an associated manner. “Medical” stored in the unified schema name 230a is an identification name for identifying the unified schema definition 23 illustrated in FIG. 3. The ETL 1 or the search server 3 can acquire the unified schema definition 23 by designating the schema name “Medical” to the dictionary managing portion 29 of the dictionary server 2 to inquire.

The description returns to FIG. 16, and in the search portion 234 of the search server 3, the search condition in which the value after the update is also included in the search condition included in the search request from the client is generated based on the update record information 230. That is, if the search condition from the client includes “Patient Name=Sato Ichiro”, the search condition in which “Suzuki Ichiro” which is the value after the update is added to the condition and which includes the search condition “Patient Name=Sato Ichiro or Suzuki Ichiro” is generated and the metadata index 4 is searched with the search condition.

More specifically, in the search server 3 that receives the search request from the client, the search condition “Patient Name: Suzuki Ichiro” is extracted. Meanwhile, the item of the update record information 230 described in the unified schema format is transformed to the search index schema format based on the schema mapping 27. If the update record information 230 after transformation includes the extracted search condition “Patient Name: Suzuki Ichiro”, the search condition is transformed to a search condition to which “Suzuki Ichiro” which is the value after the update is added.

Thereafter, the metadata index 4 is searched with the search condition after the transformation and the search result is sent to the client as a response.

The above is the configuration of the computer system 200.

Subsequently, the flow of the process of the computer system 200 is described.

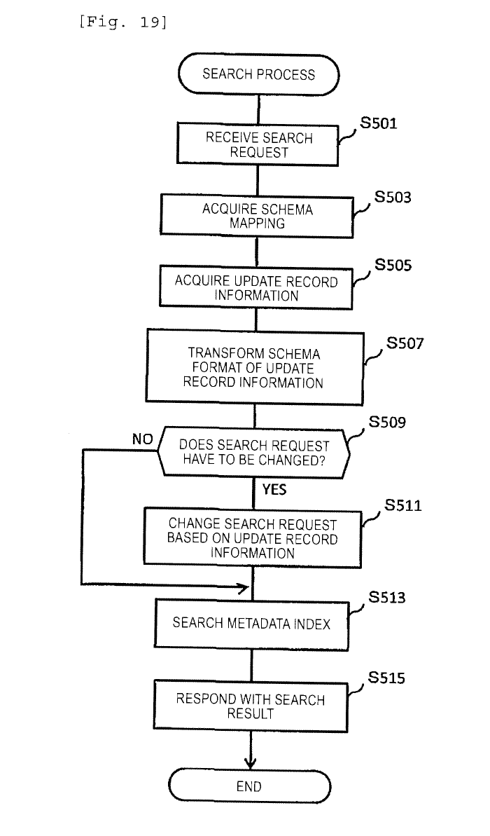

FIG. 18 is a flow chart illustrating a flow of the metadata update process.

In S401, the ETL 1 receives the metadata update request (“PAT-ID: 100”, “PAT-NAME: Suzuki Ichiro”) from the external system 7.

In S403, the ETL 1 transmits the generation and acquisition request of the schema mapping 27 to the dictionary server 3, and receives schema mapping in which the respective items of the unified schema definition 23 and the update request schema definition 26 are associated.

In S405, the ETL 1 refers to the schema mapping 27, and specifies the unified schema definition item name (“PID”) corresponding to “PAT-ID” which is the item for identifying the metadata of the update target in the update request. Further, the schema key “PID: 100” is obtained from “100” which is the value corresponding to “PID” and “PAT-ID”.

In S407, the ETL 1 designates the schema key “PID: 100”, and searches the metadata 51 stored in the storage subsystem 5.

In S409, the ETL 1 acquires the metadata 51 which is the search result and the unified ID 50 associated with the metadata.

In S411, the ETL 1 refers to the schema mapping 27, and specifies the unified schema definition item name (“PName”) corresponding to the item name (“Patient Name”) that becomes the update target, among the metadata update requests from the external system 7.

In S413, the ETL 1 extracts the value of “PName” (“Sato Ichiro”/value before update) which is the update target item from the metadata stored in the storage subsystem 5 which is acquired in S409, and transmits the unified schema item name “PName” acquired in S411 and a value of the update target item (“Suzuki Ichiro”/value after update) included in the update request from the external system 7 to the dictionary server 2. The dictionary server 2 associates and maintains the items as the update record information 230.

In S415, the ETL 1 transfers the fact that the metadata update is received, to the external system 7 which is the update request source. Also, in 5417, the update of the metadata of the storage subsystem 5 is performed based on the unified ID specified in S407.

The above is the metadata update process.

Subsequently, the search process of the search server 3 that processes the search request from the client by using the update record information 230 maintained in this manner is described.

FIG. 19 is a flow chart illustrating a flow of the metadata search process using the update record information 230.

In S501, the search portion 234 of the search server 3 receives the search request from the client. The search request is transmitted with the value of the metadata after the update (“Suzuki Ichiro” is the search condition). In addition, the search request has a format of the search index schema definition 25 which is the schema definition of the search server 3. In the example, the search request from the client is performed by using “Patient Name: Suzuki Ichiro” as the search condition.

In S503, the dictionary reference portion 35 transmits the generation and acquisition request of the schema mapping 27 to the dictionary server 2. The schema mapping 27 indicates the correspondence between the unified schema definition 23 and the item name of the search index schema definition 25.

In addition, in S505, the dictionary reference portion 35 transmits the acquisition request of the update record information 230 to the dictionary server 2, and acquires the update record information 230.

In 5507, the search portion 234 refers to the schema mapping 27, and transforms the item of the update record information 230 described in the unified schema definition 23 to the format of the search index schema definition 25. That is, the search portion 234 transforms “PName” indicating the patient's name on the update record information 230 to “Patient Name”, and obtains the update record information 230 of the item name “Patient Name”, the metadata value before the update “Sato Ichiro”, and the metadata value after the update “Suzuki Ichiro”.

In S509, the search portion 234 determines whether the update record information 230 of the search index schema format obtained in S507 includes the client search condition “Patient Name: Suzuki Ichiro”. If the update record information 230 includes the client search condition (S509: Yes), the process proceeds to S511, and if the update record information 230 does not include the client search condition (S509: No), the process proceeds to S513.

In S511, the search portion 234 newly generates the search condition from the client based on the update record information 230 transformed by the schema format. That is, the search condition from the client is changed from “Patient Name: Suzuki Ichiro” to “Patient Name: Suzuki Ichiro or Sato Ichiro”.

In 5513, the search portion 234 searches the metadata index 4 in the search condition after the change, and sends a search result to the client as a response in S515.

The above is the search process.

In this manner, according to the computer 200 according to the second embodiment, when the metadata update is generated, the existing metadata index 4 itself is not updated, and a metadata index update load is not generated.

In addition, the metadata searching in which the update in the unit of the search request from the client is reflected becomes possible.

There is an effect of preventing the increase of the process load of the ETL 1. The ETL 1 generates the load in the processes of the data storing process in the storage subsystem 5, the metadata update process, the data collection, the metadata update request reception, and the schema transformation. There is an effect in that the process load in the update process of the metadata index 4 is transferred to the search server 3.

In the above, the embodiments for practicing the invention are described, but the invention is not limited to the examples described above, but can be realized by various configuration and process orders without departing from the scope of the invention.

For example, according to the embodiment, examples of the storing process of the update process in the metadata units of the respective schema formats are described, but all items of the schemas do not have to be configured so as to be updated, and the items of the schemas may be managed by classifying the items into updatable common items and the other items. For example, a portion relating to the patient's name is managed as a common meta-file to be a common item, and the examination history accompanied by the portion may be managed to be linked to the common metadata. In this case, when the update process is performed on the specific metadata, only the common metadata having an item relating to the patient's name may be considered as a process target, and metadata of the other items is not the process target, so that there is an advantage in that the various process loads decrease as much as a handled amount of the data decreases.

Further, a configuration example in which the metadata and the actual data are independently managed is described, but it is obvious that the invention can be applied to a data management method of managing the metadata as accompanied information of the actual data. However, in the case of such a configuration, in addition to the metadata, the actual data has to be accompanied by the process in the system, so there is a concern that the data amount dealt by the various processes becomes great.

Here, the update process is preferably performed by providing pointer files (dummy files) of the actual metadata as pointer information to the portion or all of the items of the metadata and designating the pointer files as the metadata described above.

In addition, it is obvious that the various programs described by the embodiments in the above may be recorded in magnetic and/or electronic non-temporary portable recording media, or may be installed in a computer system via the network.

### REFERENCE SIGNS LIST

1 . . . ETL 1, 2 . . . DICTIONARY SERVER, 3 . . . SEARCH SERVER, 4 . . . METADATA INDEX, 5 . . . STORAGE SUBSYSTEM, 6 . . . DATA SOURCE, 7 . . . EXTERNAL SYSTEM, 23 . . . UNIFIED SCHEMA, 24 . . . IMAGE SCHEMA, 25 . . . INDEX SCHEMA, 26 . . . UPDATE REQUEST SCHEMA, 27 . . . SCHEMA MAPPING, 50a, 50b . . . UNIFIED ID, 60a, 60b . . . IMAGE FILE, 51a, 51b METADATA

1. A computer system comprising:
a storage portion that maintains schema correspondence information indicating correspondence of metadata described in different schema formats;
a storage device that stores metadata in a second schema format different from a first schema format, which is transformed based on the schema correspondence information in a manner of being associated with corresponding actual data and a unified ID;
an index portion that acquires the metadata and the unified ID in the second schema format from the storage device and maintains the metadata index transformed in a third schema format different from the first and second schema formats based on the schema correspondence information; and
an update managing portion that specifies the unified ID of the metadata to be an update target by using the schema correspondence information in response to an update request of the metadata having a predetermined schema format.

2. The computer system according to claim 1,
wherein the update managing portion transforms the schema format of the update request having the predetermined schema format to the second schema format based on the schema correspondence information, to specify the unified ID of the metadata to be the update target.

3. The computer system according to claim 2,
wherein the update managing portion specifies the unified ID of the metadata to be the update target, using data included in the update request transformed to the second schema format as a key.

4. The computer system according to claim 3,
wherein the update managing portion searches the metadata in the second schema format stored in the storage device with the key, and specifies the unified ID corresponding to the metadata as a search result.

5. The computer system according to claim 1,
wherein the update managing portion outputs an update instruction of the metadata index which includes the specified unified ID to the index portion, and
the index portion updates an update target index based on the unified ID included in the update instruction of the metadata index.

6. The computer system according to claim 5,
wherein the update managing portion further transforms the predetermined schema format of the update request to the third schema format based on the schema correspondence information, causes an update instruction of the metadata index to include the schema format, and outputs the update instruction to the index portion, and
the index portion updates an update target index based on the unified ID included in the update instruction and the update request transformed to the third schema format.

7. The computer system according to claim 5,
wherein the update managing portion further outputs the update instruction of the metadata which includes a specific unified ID and is stored in the storage device to storage device.

8. The computer system according to claim 1,
wherein the predetermined schema format of the update request is at least different from the second schema format.

9. A metadata management method of a computer system configured with a plurality of computer modules for using metadata in the same meaning in a different schema format, the method comprising:
a step of causing a management module that manages the computer system to transform input metadata in a first schema format to metadata in a second schema format different from the first schema format based on schema correspondence information indicating correspondence of the metadata in the different schema format, and outputs the transformed metadata to a storage device in a manner of being associated with corresponding actual data and a unified ID;
a step of causing an index module that manages a metadata search index of data stored in the storage device to acquire the metadata and the unified ID in the second schema format from the storage device and maintain the metadata index transformed in a third schema format different from the first and second schema formats based on the schema correspondence information; and
a step of causing the management module to receive an update request of the metadata in a predetermined schema format, so that the update request specify the unified ID of the metadata to be an update target by using the schema correspondence information.

10. A recording medium that non-temporarily stores a program causing a computer to perform:
a process of maintaining schema correspondence information indicating correspondence of metadata described in a different schema format;
a process of transforming input metadata in a first schema format to metadata in a second schema format different from the first schema format based on the schema correspondence information, and outputs the transformed metadata to a storage device in a manner of being associated with corresponding actual data and a unified ID;
a process of generating a metadata index in a third schema format different from the first and second schema formats from the metadata and the unified ID in the second schema format output from the storage device based on the schema correspondence information;
a process of receiving an update request of the metadata having a predetermined schema format, and searching metadata in a second schema format output to the storage device by an update request transformed to the second schema format using the schema correspondence information; and
a process of acquiring the unified ID corresponding to a search result so that the update request specify the unified ID of the metadata to be an update target.
